(19) United States
(12) Patent Application Publication
(10) Pub. No.: US 2013/0254856 A1
(43) Pub. Date: Sep. 26, 2013

(54) Password Generation And Management

(71) Applicant: Baldev Krishan, Fremont, CA (US)

(72) Inventor: Baldev Krishan, Fremont, CA (US)

(21) Appl. No.: 13/653,692

(22) Filed: Oct. 17, 2012

Related U.S. Application Data
(60) Provisional application No. 61/548,321, filed on Oct. 18, 2011.

(51) Int. Cl. G06F 21/00; G06F 3/048

(52) U.S. Cl. 726/6

(57) ABSTRACT

A computer implemented method and system for generating and managing multiple passwords associated with multiple online accounts is provided. The computer implemented method and system provides a password management platform accessible by a computing device via a network. The password management platform acquires information on the online accounts and user passwords associated with the online accounts via a graphical user interface (GUI) provided by the password management platform. The password management platform generates one or more unique secure random passwords to replace the user passwords for each of the online accounts on receiving an indication via the GUI. The password management platform stores the generated unique secure random passwords associated with each of the online accounts for managing access to each of the online accounts. The password management platform provides direct and secure access to the online accounts using the stored user passwords or the generated unique secure random passwords.

### CROSS REFERENCE TO RELATED APPLICATIONS

This application claims the benefit of provisional patent application No. 61/548,321 titled “Password Management Platform”, filed on Oct. 18, 2011 in the United States Patent and Trademark Office.

The specification of the above referenced patent application is incorporated herein by reference in its entirety.

### BACKGROUND

Currently most accounts on the internet, for example, electronic mail (email) accounts, social networking accounts, electronic commerce accounts, etc., require user identification details and associated passwords for gaining access to the accounts. Some users tend to create different passwords for different online accounts, for example, based on the level of security desired. Where different passwords are created by a user for different accounts, users need to remember a large number of passwords which may be problematic or difficult to remember. Hence, there is a need for a method and system that manages a large number of passwords associated with multiple accounts to make it easier for users to log into these accounts.

Most often users create generic passwords even for online accounts requiring high levels of security, which can easily be copied and/or hacked into, thereby compromising the security of the online accounts. Some users use passwords which are the same as the passwords used for accessing corporate resources, thereby compromising the security of the corporate resources. Moreover, users often use public access points that implement Wi-Fi® of the Wireless Ethernet Compatibility Alliance, Inc., and that are either encrypted or open, for example, at a restaurant or from an unknown source, which can be hacked into. Wi-Fi® networks improve connectivity but also cause potential security threats to the users. Therefore, there is a need for a method and system that provides security to online accounts that are accessed through WiFi®.

Hence, there is a long felt but unresolved need for a computer implemented method and system that generates unique secure random passwords to replace generic user passwords at periodic time intervals, manages multiple passwords associated with multiple online accounts of a user, and provides security to online accounts that are accessed through a wireless communication protocol, for example, WiFi®.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above mentioned needs for generating unique secure random passwords to replace generic user passwords associated with multiple online accounts of a user at periodic time intervals, managing multiple passwords associated with the online accounts, and providing security to online accounts that are accessed through a wireless communication protocol, for example, Wi-Fi® of the Wireless Ethernet Compatibility Alliance, Inc. As used herein, the term “online account” refers to a user account, for example, an electronic mail account, an internet bank transaction account, a social networking user account, a corporate account, an electronic commerce account, etc. Also, as used herein, the term “password” refers to a string of characters, for example, letters, numbers, special characters, symbols, etc., and any combination thereof, that is used for authentication and for gaining access to a resource, for example, an online account. The computer implemented method and system disclosed herein provides a password management platform accessible by a user's computing device via a network. The password management platform comprises at least one processor configured to generate and manage the passwords associated with the online accounts.

The password management platform registers users associated with the online accounts via a graphical user interface (GUI) provided by the password management platform. A user may create a user account on the password management platform by providing user information, for example, a chosen user name, a password, biometric information comprising one or more biometric identifiers of the user, contact information, user preferences, etc., via the GUI. Examples of biometric identifiers comprise the user's fingerprint, an iris scan, hand geometry, a palm print, a foot print, a face image, ear shapes, voice prints, gait measurements, keystroke patterns, signature dynamics, etc. The password management platform generates and transmits a temporary password, for example, to the user's email address, and a verification code to the user's computing device via the network using one or more of multiple communication modes, for example, electronic mail, a short message service, a multimedia messaging service, a telephonic communication, etc., for allowing access to the password management platform. The verification code is, for example, a random code or a fixed code.

In an embodiment, once the user account is set up on the password management platform with a chosen user name and password, the password management platform generates and transmits an authentication request, for example, to the user's email address or to the user's computing device using one or more of multiple communication modes, for example, electronic mail, a short message service, a multimedia messaging service, a telephonic communication, etc., via the network. The authentication request comprises, for example, a request for one or more biometric identifiers for performing biometric authentication of the user for allowing the user to access the password management platform. Biometric authentication refers to verifying an identity of a user by measuring and analyzing data relative to his/her physiological characteristics, behavioral characteristics, or traits. In another embodiment, the password management platform transmits both a verification code and an authentication request, for example, to the user's email address or to the user's computing device using one or more of the communication modes, via the network for authenticating the user and allowing access to the password management platform.

The password management platform acquires information on the online accounts and user passwords associated with the online accounts via the GUI. The information associated with the online accounts comprises, for example, user information such as a user name, an electronic mail address associated with each of the online accounts, access identifiers for accessing the online accounts, login information, etc. The password management platform generates one or more unique secure random passwords to replace the user passwords for each of one or more of the online accounts, on receiving an indication from the user via the GUI. The generated unique secure random passwords comprise, for example, one or more of a random number, a random string of alphanumeric characters, symbols, etc., and any combination thereof. The password management platform stores the generated unique secure random passwords associated with each of the online accounts for managing access to each of the online accounts. In an embodiment, the password management platform selectively stores the user passwords or the generated unique secure random passwords associated with the online accounts based on user preferences.

The password management platform provides a database configured to store the acquired information on the online accounts, the user passwords associated with the online accounts, the generated unique secure random passwords, updates to the acquired information on the online accounts and the user passwords associated with the online accounts, user preferences, etc. The password management platform generates and displays prompts to update the online accounts with the generated unique secure random passwords prior to accessing the online accounts via the password management platform. As used herein, the term “prompts” refers to alerts or notifications generated and transmitted by the password management platform via the GUI to alert a user to perform an action. In an embodiment, the password management platform provides direct access to the online accounts using the user passwords or the generated unique secure random passwords. In another embodiment, the password management platform also provides secure access to the online accounts via a wireless communication protocol, for example, Wi-Fi® using the user passwords or the generated unique secure random passwords. In an embodiment, the password management platform acquires updates to the acquired information on the online accounts and the user passwords associated with the online accounts via the GUI. As used herein, the term “updates” refers to the changes made to the online account information, the user name, password, user information, user preferences, etc.

In an embodiment, the password management platform configures a time interval for automatically generating unique secure random passwords for each of the online accounts based on user preferences. The password management platform transmits a password notification to each of the online accounts via the network to replace the user passwords with the generated unique secure random passwords. Furthermore, in an embodiment, the password management platform transmits an intimation, for example, to the user's email address or to the user's computing device via the network using one or more of the communication modes, regarding the replacement of the user passwords with the generated unique secure random passwords to allow the user to access the online accounts with the generated unique secure random passwords.

In an embodiment, the password management platform bookmarks one or more of the online accounts based on user preferences. As used herein, the term “bookmark” refers to an action where the password management platform assigns a pointer or a uniform resource identifier (URI) to an online account, which is stored for later retrieval in multiple storage formats, for example, as a web link marked as a favorite, an internet shortcut, etc., for providing access to the online account. The bookmarked online accounts are accessed, for example, through a menu in the user's web browser. The password management platform automatically inputs user names extracted from the acquired information of the bookmarked online accounts and either the user passwords or the generated unique secure random passwords associated with the bookmarked online accounts, when the bookmarked online accounts are accessed via the password management platform. In another embodiment, the password management platform generates and transmits a verification code accessible to the user's computing device via the network to provide access to the bookmarked online accounts, when the bookmarked online accounts are accessed independent of the password management platform. In another embodiment, the password management platform generates and transmits an authentication request accessible to the user's computing device via the network to provide access to the bookmarked online accounts, when the bookmarked online accounts are accessed independent of the password management platform. The authentication request comprises, for example, a request for one or more biometric identifiers that allow the password management platform to perform biometric authentication of the user and provide access to the bookmarked online accounts. In another embodiment, the password management platform generates and transmits both a verification code and an authentication request accessible to the user's computing device via the network to provide access to the bookmarked online accounts, when the bookmarked online accounts are accessed independent of the password management platform.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for generating and managing multiple passwords associated with multiple online accounts.

FIG. 2 exemplarily illustrates interfaces provided by a password management platform configured to generate and manage multiple passwords associated with multiple online accounts.

FIG. 3 exemplarily illustrates a graphical user interface of the password management platform, displaying a list of online accounts of a user and options for creating passwords for the online accounts.

FIG. 4 exemplarily illustrates a graphical user interface of the password management platform, displaying a unique secure random password generated by the password management platform for an online account of a user.

FIG. 5 exemplarily illustrates a graphical user interface of the password management platform for changing a password associated with an online account and for allowing secure access to the online account using the changed password.

FIGS. 6A-6B exemplarily illustrate a flowchart comprising the steps performed by the password management platform for generating a unique secure random password.

FIG. 7 exemplarily illustrates a computer implemented system for generating and managing multiple passwords associated with multiple online accounts.

FIG. 8 exemplarily illustrates the architecture of a computer system employed by the password management platform for generating and managing multiple passwords associated with multiple online accounts.

FIGS. 9A-9B exemplarily illustrate a flowchart comprising the steps performed by the password management platform for generating and managing multiple passwords associated with multiple online accounts of a user.

FIG. 10 exemplarily illustrates a flowchart comprising the steps performed by the password management platform when a user accesses bookmarked online accounts.

### DETAILED DESCRIPTION OF THE INVENTION

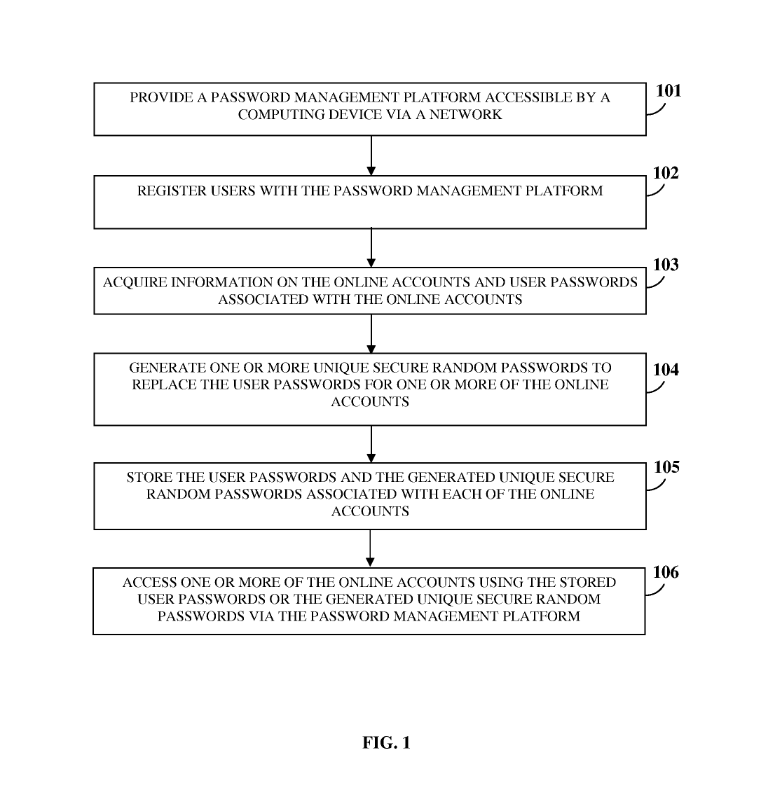

FIG. 1 illustrates a computer implemented method for generating and managing multiple passwords associated with multiple online accounts. As used herein, the term “online account” refers to a user account, for example, an electronic mail account, an internet bank transaction account, a social networking user account, a corporate account, an electronic commerce account, etc. Also, as used herein, the term “password” refers to a string of characters, for example, letters, numbers, special characters, symbols, etc., and any combination thereof, that is used for authentication and for gaining access to a resource, for example, an online account. The computer implemented method disclosed herein provides 101 a password management platform accessible by a user's computing device via a network. The password management platform is, for example, hosted on a server or a network of servers that is accessible to the user via the network. The computing device is, for example, a networked computer, a laptop, a mobile phone, a tablet computing device, a personal digital assistant, etc. The network is, for example, the internet, an intranet, a local area network, a wide area network, a communication network that implements Wi-Fi® of the Wireless Ethernet Compatibility Alliance, Inc., a cellular network, a mobile communication network, etc., and any combination thereof. The mobile communication network is, for example, a global system for mobile communications (GSM) network, a general packet radio service (GPRS) network, a third generation (3G) mobile communication network, a fourth generation (4G) mobile communication network, etc. The computer implemented method disclosed herein employs a computer system comprising at least one processor communicatively coupled to a non-transitory computer readable storage medium configured to store instructions executable by the processor, where the processor is configured to implement the method disclosed herein. The password management platform comprises at least one processor configured to generate and manage passwords associated with the online accounts. The password management platform is accessible to the user, for example, through a wide spectrum of technologies and devices such as computers with connection to the internet, internet-enabled cellular phones, tablet computing devices, etc.

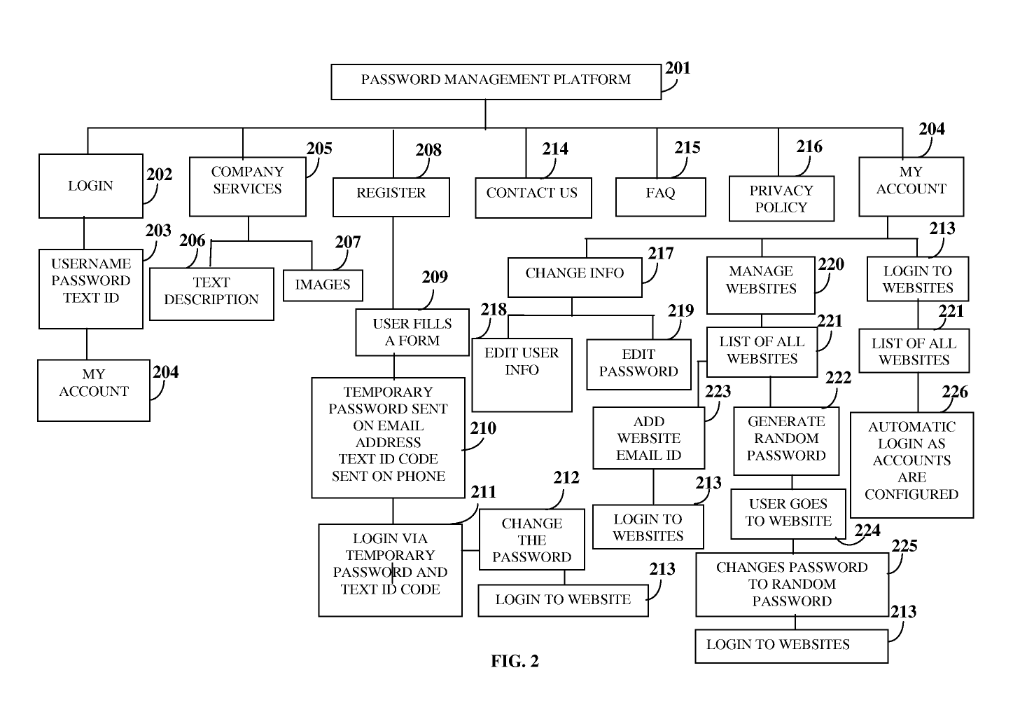

In an embodiment, the password management platform registers 102 users associated with the online accounts via a graphical user interface (GUI) provided by the password management platform. The password management platform registers the users by acquiring user information, for example, a user name, password, biometric information comprising one or more biometric identifiers of the user, contact information, user preferences, etc., from the user via the GUI as disclosed in the detailed description of FIG. 2. Examples of biometric identifiers comprise the user's fingerprint, an iris scan, hand geometry, a palm print, a foot print, a face image, ear shapes, voice prints, gait measurements, keystroke patterns, signature dynamics, etc. Furthermore, on registering and setting up a user account with the password management platform, the password management platform generates and transmits a temporary password, for example, to the user's electronic mail address, abbreviated herein as email, and a verification code to the user's computing device via the network using one or more of multiple communication modes for allowing access to the password management platform. The verification code is, for example, a random code or a fixed code. As used herein, the term “communication modes” refers to modes of communicating and transmitting information, notifications, prompts, alerts, etc., to the user. The communication modes comprise, for example, electronic mail, a short message service, a multimedia messaging service, telephonic communication, etc. In an example, the password management platform transmits a temporary password to the user's email address and a text message with a verification code to the user's computing device to allow the user to login to the password management platform. The verification code is either a random code or a fixed code transmitted to the user's computing device. The user utilizes the verification code for accessing the password management platform to add, edit, view, and manage online accounts on the password management platform.

In another embodiment, once the user sets up a user account with the password management platform with a chosen user name and password, the password management platform provides another factor of user authentication configurable in the password management platform. In this embodiment, the password management platform generates and transmits an authentication request accessible to the user's computing device via the network using one or more communication modes for allowing access to the password management platform. The authentication request comprises, for example, a request for one or more biometric identifiers from the user. The user is requested to provide one or more biometric identifiers to allow the password management platform to perform biometric authentication of the user and to allow access to the password management platform to add, edit, view, and manage online accounts on the password management platform. Biometric authentication refers to verifying an identity of a user by measuring and analyzing data relative to his/her physiological characteristics, behavioral characteristics, or traits. The user's physiological characteristics are defined by physiological biometric identifiers. Examples of physiological biometric identifiers are a retina, an iris, a hand image, fingerprints, palm prints, footprints, facial images, ear shapes, etc. A “fingerprint” is a biometric identifier that refers to either a print of the user's thumb, an index finger, any other finger, or a combination thereof. A “footprint” is a biometric identifier that refers to either a print of any of the user's toes or any combination of the user's toes. A “facial image” is a biometric identifier that refers, for example, to the user's facial geometry, facial thermal pattern, iris, retina, etc. A “hand image” biometric identifier refers, for example, to a fingerprint, a thumbprint, a palm print, hand cell capture, deoxyribonucleic acid (DNA), hand geometry, etc. The user's behavioral characteristics are defined by behavioral biometric identifiers. Examples of behavioral biometric identifiers are voice, gait measurement, keystroke rhythms, a signature, etc. The password management platform performs biometric authentication of the user by verifying the biometric identifiers provided by the user in the response to the authentication request with the biometric information provided by the user during registration. In another embodiment, the password management platform generates and transmits both a verification code and an authentication request, for example, to the user's email address or to the user's computing device via the network using one or more of the communication modes, for authenticating the user and allowing access to the password management platform.

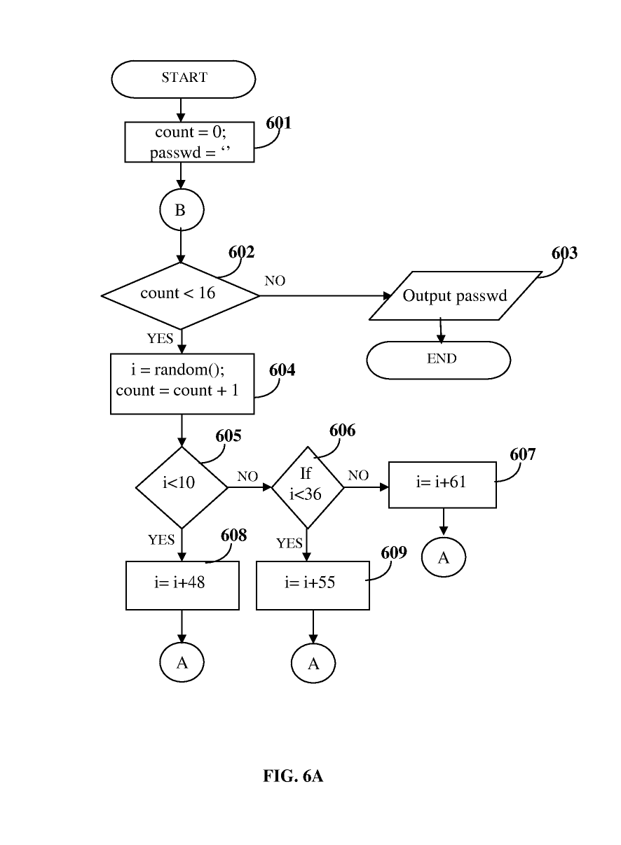

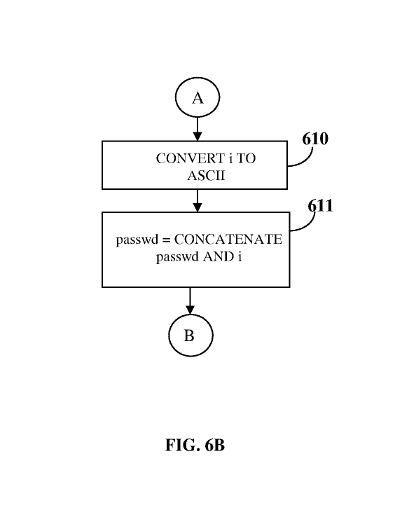

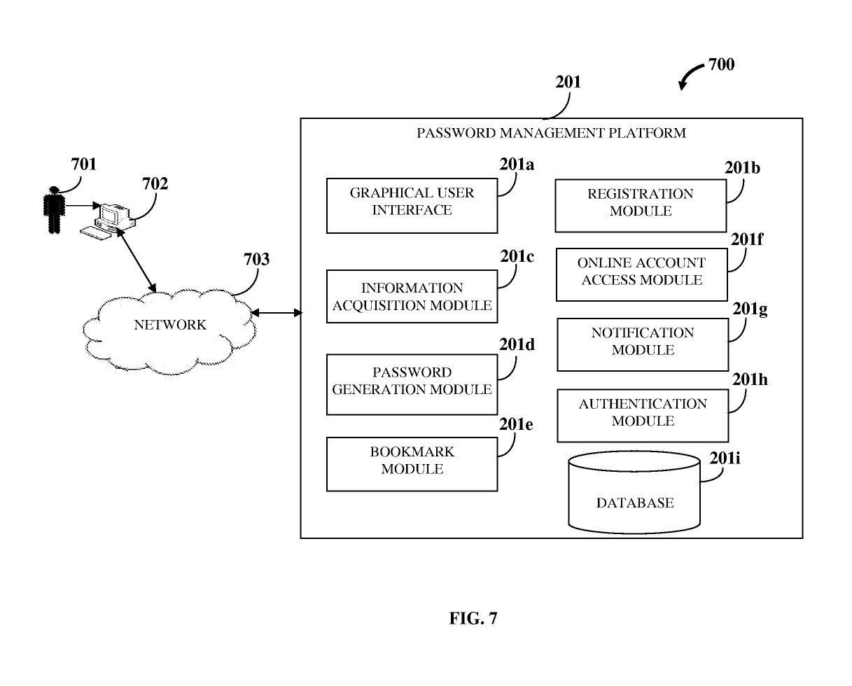

The password management platform acquires 103 information on the online accounts, for example, a uniform resource locator (URL), an email address to each of the online accounts, a user name, access identifiers for accessing the online accounts, login information, etc., and user passwords associated with the online accounts from the user via the GUI. The online accounts are, for example, electronic mail (email) accounts, social networking accounts, electronic commerce accounts, website accounts, etc. As used herein, the term “user passwords” refers to passwords created by the user for accessing the online accounts. The password management platform generates 104 one or more unique secure random passwords to replace the user passwords for one or more of the online accounts, on receiving an indication from the user via the GUI as disclosed in the detailed description of FIG. 4 and FIGS. 6A-6B. The unique secure random passwords comprise, for example, one or more of a random number, a random string of alphanumeric characters, symbols, etc., and any combination thereof. The password management platform enables the user to change the user passwords associated with the online accounts to randomly generated unique secure random passwords as disclosed in the detailed description of FIG. 5. Furthermore, the password management platform generates and displays prompts to update the online accounts with the generated unique secure random passwords prior to accessing the online accounts via the password management platform. As used herein, the term “prompts” refers to alerts or notifications generated and transmitted by the password management platform via the GUI to alert the user to perform an action, for example, update the online accounts with the generated unique secure random passwords.

The password management platform stores 105 the user passwords and the generated unique secure random passwords associated with each of the online accounts for managing access to each of the online accounts. In an embodiment, the password management platform selectively stores either the user passwords or the generated unique secure random passwords associated with the online accounts based on user preferences. The user preferences comprise options or settings selected or configured by the user on the password management platform via the GUI based on the user's choice. The password management platform provides the user with an option to store and use the generated unique secure random passwords or retain the previous user passwords. Once the user configures user preferences on the password management platform via the GUI, the password management platform stores the configured user preferences to provide access to the online accounts.

The password management platform provides a database configured to store the acquired information on the online accounts, the user passwords associated with the online accounts, the generated unique secure random passwords, updates to the acquired information on the online accounts and the user passwords associated with the online accounts, user preferences, etc. In an embodiment, the password management platform provides direct access 106 to the online accounts using the stored user passwords or the generated unique secure random passwords via the password management platform. The user can therefore securely access one or more of the online accounts using the stored user passwords or the generated unique secure random passwords via the password management platform. In an embodiment, the password management platform acquires updates to the acquired information on the online accounts and the user passwords associated with the online accounts via the GUI. The password management platform is configured to store the acquired updates in the database maintained by the password management platform.

In an embodiment, the password management platform bookmarks one or more of the online accounts based on user preferences. As used herein, the term “bookmark” refers to an action where the password management platform assigns a pointer or a uniform resource identifier (URI) to an online account, which is stored for later retrieval in multiple storage formats, for example, as a web link marked as a favorite, an internet shortcut, etc., for providing access to the online account. The bookmarked online accounts are accessed, for example, through a menu in the user's web browser. In an embodiment, the password management platform automatically inputs user names extracted from the acquired information of the bookmarked online accounts and either the user passwords or the generated unique secure random passwords associated with the bookmarked online accounts when the bookmarked online accounts are accessed by the user via the password management platform. In an example, if a user accesses the password management platform and wishes to log into the bookmarked online accounts via the password management platform, the password management platform automatically refills the user names and either the user passwords or the generated unique secure random passwords associated with the bookmarked online accounts to allow the user to log into the bookmarked online accounts.

In another embodiment, when the user accesses the bookmarked online accounts independent of the password management platform, the password management platform generates and transmits a verification code accessible to the user's computing device via the network to provide access to the bookmarked online accounts. If a user directly logs into the bookmarked online accounts from a computing device where the password management platform has bookmarked the user's online accounts directly, without first logging into the password management platform, the password management platform transmits a verification code, for example, to the user's computing device using one or more communication modes, via electronic mail (email), etc. The user receives the verification code on the computing device or via email and uses the verification code to access the bookmarked online accounts independently without accessing the password management platform.

In another embodiment, the password management platform generates and transmits an authentication request accessible to the user's computing device via the network to provide access to the bookmarked online accounts, when the bookmarked online accounts are accessed independent of the password management platform. The authentication request comprises, for example, a request for one or more biometric identifiers that allow the password management platform to perform biometric authentication of the user. For example, password management platform transmits an authentication request for a biometric identifier to the user via email or any of the communication modes, to perform biometric authentication of the user. The password management platform performs biometric authentication of the user by verifying the biometric identifier provided by the user in the response to the authentication request with the biometric information provided by the user during registration. In another embodiment, the password management platform generates and transmits both a verification code and an authentication request accessible to the user's computing device via the network to provide access to the bookmarked online accounts, when the bookmarked online accounts are accessed independent of the password management platform.

In an embodiment, the password management platform configures a time interval for automatically generating the unique secure random passwords for each of the online accounts based on user preferences. For example, the user may define instructions to the password management platform via the GUI to automatically generate a unique secure random password for each of the user's internet banking accounts every two weeks. The password management platform configures the time interval to two weeks for each of the user's internet banking accounts and automatically generates a unique secure random password for each of the user's internet banking accounts every two weeks. In an embodiment, the password management platform transmits a password notification to each of the online accounts via the network to replace the user passwords with the generated unique secure random passwords. Furthermore, in an embodiment, the password management platform transmits an intimation, for example, to the user's email address or to the user's computing device via the network using one or more of the communication modes, regarding the replacement of the user passwords with the generated unique secure random passwords to allow the user to access the online accounts with the generated unique secure random passwords. On receiving the intimation, the user then uses the automatically generated unique secure random passwords to access the associated online accounts.

The password management platform enables the user to manage the usernames and the passwords of the user's online accounts in one central location managed by the password management platform. In an embodiment, the password management platform allows an automatic login to the online accounts when the online accounts provide an application programming interface (API) that allows the automatic login. For example, the password management platform can automatically log into a user's Facebook® account maintained by Facebook, Inc. For the online accounts that do not provide the API that allows the automatic login, a single document interface (SDI) of the password management platform implements a separate programmed logic for those online accounts in order to automatically fill login information, for example, a username, a password, etc., associated with the online account. The username is, for example, a name of the user, an email address of the user, etc. The login information comprises, for example, the email address and the associated password for logging into a Facebook® account.

In another embodiment, the password management platform also provides secure access to the online accounts via a wireless communication protocol, for example, Wi-Fi® using the user passwords or the generated unique secure random passwords. The password management platform enables the user to securely access the user's online accounts through Wi-Fi®. The user first accesses the password management platform when the user starts browsing. The password management platform provides a secure connection between the user's computing device and a server that hosts the password management platform. On authentication of the user, the password management platform allows the user to log into the user's online accounts through the password management platform. The password management platform provides a secure connection between the server of the password management platform and the servers of the user's online accounts. The password management platform disclosed herein provides the user a one-click solution to access online accounts securely. The password management platform is simple and intuitive to use, and stores passwords of multiple different online accounts at a centralized location managed by the password management platform.

FIG. 2 exemplarily illustrates interfaces provided by the password management platform 201 configured to generate and manage multiple passwords associated with multiple online accounts. The password management platform 201 is configured, for example, as a website comprising a graphical user interface (GUI), through which a user registers with the password management platform 201. The user registers with the password management platform 201 by creating a user account with a user name and a user password to access the password management platform 201. The password management platform 201 acquires user information, for example, the user's full name, a username, an electronic mail (email) address, a phone number, biometric information, etc., via the GUI for registering the user with the password management platform 201. In an example, the password management platform 201 provides a form to the user via the GUI for acquiring the required user information. The user fills 209 the form with the required user information and submits the form to the password management platform 201. The password management platform 201 creates a user account for the user for registering the user with the password management platform 201.

On completion of the registration, the password management platform 201 allows the user to login 202 to the user account, after the password management platform 201 sends 210 a temporary password to the user's email address of the user and, for example, a text message 210 to the phone number of the user's computing device. The text message comprises, for example, a verification code or identifier (ID). The user logs into the password management platform 201 via the GUI of the password management platform 201 by providing the username, the temporary password, and the ID 203 obtained from the text message. The password management platform 201 then prompts the user to change 212 the temporary password. The password management platform 201 acquires a new password from the user. The password management platform 201 then confirms the password change by requesting the user to re-enter the new password. On confirmation of the password, the password management platform 201 assigns the new password as the password for logging into the password management platform 201. The password management platform 201 transmits the new password to the user, for example, via email. The user can enter the username, the new password, and the ID 203 obtained from the text message for logging into the user account on the password management platform 201. In an embodiment, the password management platform 201 enables the user to modify the user information. For example, the user can change the password, the phone number, etc., on the password management platform 201. The password management platform 201 then notifies the modified user information to the user, for example, via email.

The password management platform 201 comprises interfaces, for example, “Login” 202, “My Account” 204, “Company Services” 205, “Register” 208, “Contact Us” 214, “Frequently Asked Questions” (FAQ) 215, “Privacy Policy” 216, etc. The password management platform 201 acquires the user's login information via the “Login” 202 interface. The login information comprises, for example, a username, the password, and the ID 203 obtained from the text message. The password management platform 201 provides information about the company, for example, in the form of a text description 206, images 207, etc., via the “Company Services” 205 interface. The user can register with the password management platform 201 via the “Register” 208 interface. During the registration process, the password management platform 201 requests the user to fill 209 a form and sends 210 a temporary password, for example, to the user's email address and a text identification (ID) code to the user's computing device, for example, a mobile phone. The user logs 211 into the user account using the temporary password and the text ID code and changes 212 the password. The user may then log into 213 or access one or more websites that host the user's online accounts via the password management platform 201.

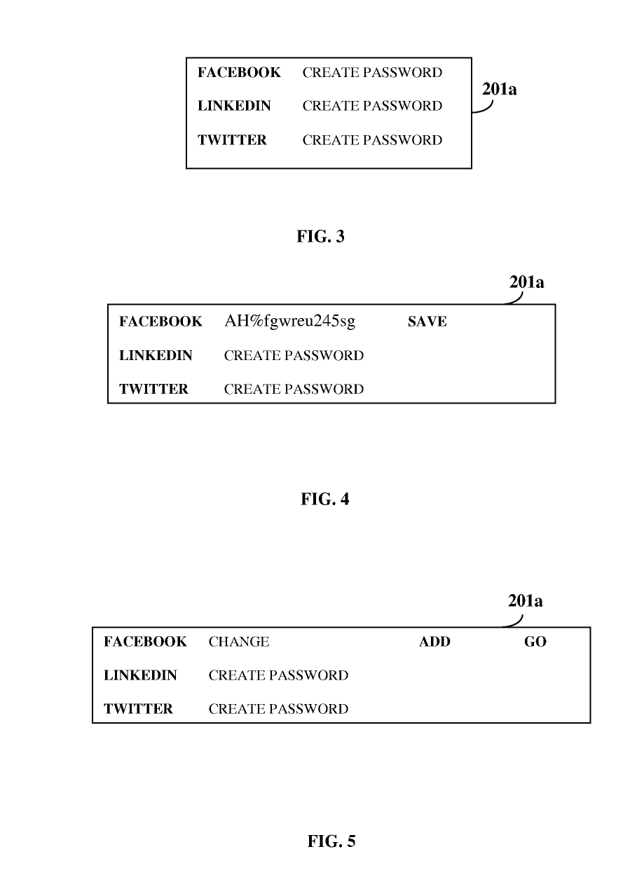

The password management platform 201 provides the contact details of the company via the “Contact Us” 214 interface. The “FAQ” 215 interface is, for example, a static webpage comprising answers to a list of questions. The “Privacy Policy” 216 interface is, for example, a static webpage that states the company's privacy policies. The password management platform 201 provides access to the user's user account via the “My Account” 204 interface. The password management platform 201 allows the user to change 217 the user information, manage 220 the user's online accounts, also referred to as “websites” associated with the user and the associated passwords, etc., via the “My Account” 204 interface as disclosed in the detailed description of FIGS. 3-5. On the “My Account” 204 interface, the password management platform 201 displays lists 221 of websites associated with the user via the GUI. The user can click on a “change information” 217 link to edit 218 the user information or edit 219 a password. Furthermore, the user can manage 220 the user's online accounts, for example, Facebook®, Twitter®, LinkedIn®, etc., maintained by associated websites and view the list of online accounts on a “List of all websites” 221 interface. The user can add 223 a website email ID, login 213 to a website, trigger generation 222 of the unique secure random password, go 224 to a website, change 225 a user password to a unique secure random password, etc., via the “List of all websites” 221 interface.

Furthermore, the password management platform 201 bookmarks one or more of the online accounts based on user preferences. The user selects the preferred online accounts from the “List of all websites” 221 interface. The password management platform 201 bookmarks the online accounts selected by the user, and when the user accesses the password management platform 201, the user is automatically signed in to the bookmarked online accounts. The password management platform 201 automatically inputs the user names extracted from the acquired information of the bookmarked online accounts and either the user passwords or the generated unique secure random passwords associated with the bookmarked online accounts when the bookmarked online accounts are accessed via the password management platform 201.

Consider an example, where the user owns an email address used by the user to log into a Facebook® account. When the user accesses the “List of all websites” 221 interface, the password management platform 201 provides a link to add the Facebook® email address on the GUI. The password management platform 201 displays an additional link, for example, “create password” next to the email address link. The create password link allows the user to generate 222 a unique secure random password for the Facebook® account associated with the email address. The password management platform 201 generates 222 the unique random password and allows the user to save the generated password in a database maintained by the password management platform 201. The password management platform 201 then prompts the user to go to 224 or visit the Facebook® website and change 225 the old user password to the generated unique random password. The user updates the Facebook® account with the generated unique random password. The user can then access the Facebook® account using the generated unique random password via the password management platform 201. The password management platform 201 provides a “login to websites” 213 link to allow the user to automatically log in 226 to one or more online accounts when the online accounts are configured. The password management platform 201 enables the user to automatically log into 226 one or more online accounts via the password management platform 201.

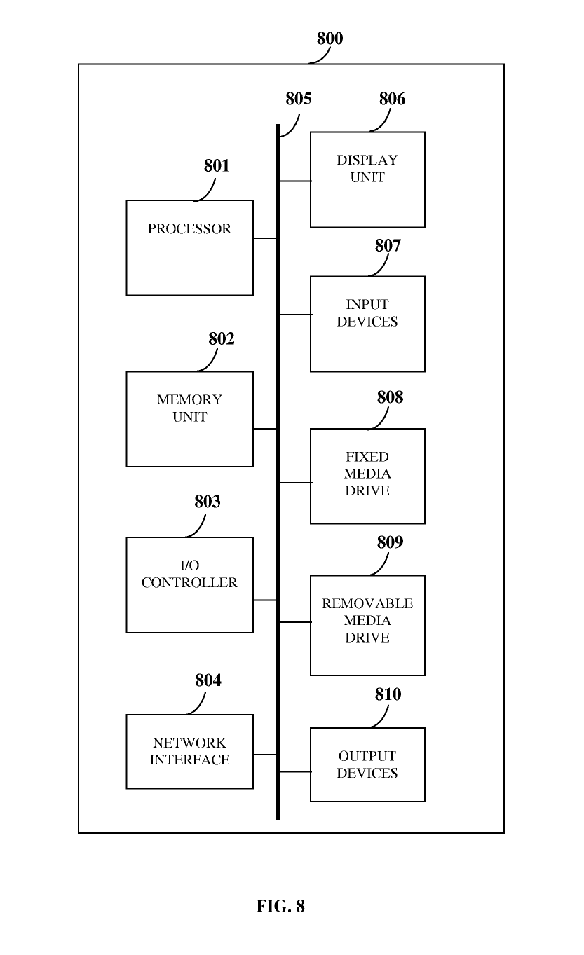

FIG. 3 exemplarily illustrates a graphical user interface (GUI) 201a of the password management platform 201 shown in FIG. 2 and FIG. 7, displaying a list of online accounts of a user and options for creating passwords for the online accounts. The password management platform 201 displays a list of the user's online accounts, for example, a Facebook® account maintained by Facebook Inc., a LinkedIn® account maintained by LinkedIn Corporation, a Twitter account maintained by Twitter, Inc., etc., on the “My Account” 204 interface exemplarily illustrated in FIG. 2, provided on the GUI 201a. The user may log into the online accounts automatically via the password management platform 201 or by entering the login information associated with the online accounts. In an embodiment, the password management platform 201 provides a “create password” link, button, or another interface element alongside the name of each online account on the “My Account” 204 interface. On clicking the “create password” button, the password management platform 201 generates a unique secure random password for the corresponding online account as disclosed in the detailed description of FIG. 4 and FIGS. 6A-6B.

FIG. 4 exemplarily illustrates a graphical user interface (GUI) 201a of the password management platform 201 shown in FIG. 2 and FIG. 7, displaying a unique secure random password generated by the password management platform 201 for an online account of a user. The password management platform 201 generates a unique secure random password for an online account, when the user clicks on the “create password” button on the “My Account” 204 interface exemplarily illustrated in FIG. 2, provided on the GUI 201a. The password management platform 201 randomly generates a unique secure random password for an online account selected by the user. The user can then log into the online account for which the password was generated on the website that hosts the online account and change the password to the unique secure random password generated by the password management platform 201. The user then returns to the “My Account” 204 interface on the password management platform 201 and clicks a “save” button. On clicking the “save” button, the password management platform 201 stores the generated unique secure random password in the database and associates the generated unique secure random password with the online account. Consider an example where the password management platform 201 generates a unique secure random password “AH%fgwreu245sg” for a user's Facebook® online account, when the user clicks on the “create password” button next to the Facebook link on the “My Account” 204 interface as exemplarily illustrated in FIG. 4. The user logs into the Facebook® account and changes the existing password to the generated unique secure random password “AH%fgwreu245sg” using a “change password” process of Facebook®. The user can enter the unique secure random password generated by the password management platform 201 and finish the “change password” process on the Facebook® website. The user can then return to the “My Account” 204 interface on the password management platform 201 and click on the “save” button to save the generated unique secure random password in the database of the password management platform 201.

FIG. 5 exemplarily illustrates a graphical user interface (GUI) 201a of the password management platform 201 shown in FIG. 2 and FIG. 7, for changing a password associated with an online account and for allowing secure access to the online account using the changed password. The password management platform 201 provides additional interface elements such as buttons labeled, for example, as “change”, “add”, “go”, etc., on the “My Account” 204 interface exemplarily illustrated in FIG. 2, provided on the GUI 201a. Clicking on the “change” button allows the user to change the password associated with the online account to the unique secure random password generated by the password management platform 201. Clicking on the “add” button allows the user to enter the corresponding email addresses for the online accounts. Clicking on the “go” button allows the user to automatically log into the online accounts via the password management platform 201 as disclosed in the detailed description of FIG. 1.

FIGS. 6A-6B exemplarily illustrate a flowchart comprising the steps performed by the password management platform 201 shown in FIG. 2 and FIG. 7, for generating a unique secure random password. In an example, the password management platform 201 executes the following pseudocode for generating a unique secure random password:
(1..size).collect{(i=Kernel.rand(62); i+=((i<10)?48: ((i<36)?55: 61))).chr}.join

Consider an example for generating a unique secure random password having 16 characters. As exemplarily illustrated in FIG. 6A, the password management platform 201 initializes 601 a variable “count” to zero and initializes 601 a variable “passwd” to a null string. The password management platform 201 then checks 602 if the variable “count” is less than 16. If the variable “count” is not less than 16, the password management platform 201 outputs 603 the variable “passwd” and terminates the process. If the variable “count” is less than 16, the password management platform 201 assigns 604 a random number to the variable “i” and increments 604 the variable “count” by 1. The password management platform 201 then checks 605 if the variable “i” is less than 10. If the variable “i” is less than 10, the password management platform 201 increments 608 the variable “i” by 48 and proceeds to step A exemplarily illustrated in FIG. 6B. If the variable “i” is not less than 10, the password management platform 201 checks 606 if the variable “i” is less than 36. If the variable “i” is less than 36, the password management platform 201 increments 609 the variable “i” by 55 and proceeds to step A exemplarily illustrated in FIG. 6B. If the variable “i” is not less than 36, the password management platform 201 increments 607 the variable “i” by 61 and proceeds to step A exemplarily illustrated in FIG. 6B.

As exemplarily illustrated in FIG. 6B, the password management platform 201 receives the variable “i”, which is an integer and lookups a table that stores the American standard code for information interchange (ASCII) characters to convert 610 the variable “i” to an ASCII character. For example, if the variable “i” is 65, the password management platform 201 maps the variable “i” to character “A”. The password management platform 201 then concatenates 611 the variable “passwd” with the mapped ASCII character. The password management platform 201 then proceeds to step B exemplarily illustrated in FIG. 6A and repeats the process until the required string of characters for the unique secure random password is generated. The password management platform 201 displays the generated unique secure random password next to the associated online account on the graphical user interface (GUI) 201a as exemplarily illustrated in FIG. 4.

FIG. 7 exemplarily illustrates a computer implemented system 700 for generating and managing multiple passwords associated with multiple online accounts. The computer implemented system 700 disclosed herein comprises a password management platform 201 accessible to a user's 701 computing device 702 over a network 703. The network 703 is, for example, the internet, an intranet, a local area network, a wide area network, a communication network implementing Wi-Fi® of the Wireless Ethernet Compatibility Alliance, Inc., a cellular network, a mobile communication network, etc. The password management platform 201 comprises at least one processor configured to execute modules 201a, 201b, 201c, 201d, 201e, 201f, 201g, 201h, and 201i of the password management platform 201. The password management platform 201 further comprises a non-transitory computer readable storage medium communicatively coupled to the processor. The non-transitory computer readable storage medium is configured to store the modules 201b, 201c, 201d, 201e, 201f, 201g, and 201h of the password management platform 201. The password management platform 201 comprises a graphical user interface (GUI) 201a, a registration module 201b, an information acquisition module 201c, a password generation module 201d, a bookmark module 201e, an online account access module 201f, a notification module 201g, an authentication module 201h, and a database 201i. The GUI 201a comprises, for example, a set of a web pages hosted on a server associated with the password management platform 201. The user 701 may register with the password management platform 201 and add, edit, and view online accounts via the GUI 201a.

The registration module 201b registers users 701 associated with the online accounts, with the password management platform 201 via the GUI 201a. When a user 701 accesses the password management platform 201, the registration module 201b prompts the user 701 to register with the password management platform 201 via the GUI 201a if the user 701 is not registered previously. If the user 701 wishes to register with the password management platform 201, the registration module 201b displays a form the user 701 has to fill out. The form requests details associated with the user 701, for example, name of the user 701, email address, telephone number, etc. The password generation module 201d generates a temporary password and a random or a fixed verification code accessible to the user's 701 computing device 702 via the network 703 for authenticating the user 701 and providing access to the password management platform 201. The notification module 201g transmits the generated temporary password, for example, to the user's 701 email address, and the random or the fixed verification code to the user's 701 computing device 702 via the network 703 using one or more of multiple communication modes, for example, electronic mail, a short message service message, a multimedia messaging service message, a telephonic message, etc., for providing access to the password management platform 201. For example, the notification module 201g sends out a temporary password, for example, to the user's 701 email address, and a verification code, for example, via a text message, etc., to the user's 701 computing device 702 to allow the user 701 to access the password management platform 201.

In an embodiment, the authentication module 201h generates an authentication request for authenticating the user 701 and providing access to the password management platform 201. The authentication request comprises, for example, a request for one or more biometric identifiers for performing biometric authentication. The notification module 201g transmits the generated authentication request, for example, to the user's 701 email address, or to the user's 701 computing device 702 using one or more of multiple communication modes, for example, electronic mail, a short message service message, a multimedia service message, a telephonic message, etc., via the network 703. The authentication module 201h performs authentication of the user 701 using a response to the authentication request received from the user's 701 computing device 702. In another embodiment, the notification module 201g transmits both a verification code and an authentication request, for example, to the user's 701 email address or to the user's 701 computing device 702 using one or more of the communication modes, via the network 703 for authenticating the user 701 and allowing access to the password management platform 201.

When the user 701 accesses the password management platform 201, the notification module 201g prompts the user 701 to enter information on the online accounts, for example, Facebook®, LinkedIn®, Twitter®, etc., on the GUI 201a. The information acquisition module 201c acquires information on the online accounts and user passwords associated with the online accounts from the user 701 via the GUI 201a. When the user 701 clicks on the “My account” 204 interface link exemplarily illustrated in FIG. 2, on the GUI 201a, the GUI 201a displays the list of websites, for example, Facebook®, LinkedIn®, Twitter®, etc., registered by the user 701. Consider an example where the user 701 has a Twitter® account. The user 701 is requested to provide information associated with the Twitter® account, for example, the user's 701 email address and the user password used to access the Twitter® account.

The password generation module 201d generates one or more unique secure random passwords comprising, for example, one or more of a random number, a random string of alphanumeric characters, symbols, etc., and any combination thereof, to replace the user passwords for each of the online accounts, on receiving an indication from the user 701 via the GUI 201a. For example, when the user 701 requests the password management platform 201 to create a password for the Twitter® account, the password generation module 201d generates a unique secure random password to replace the user password of the Twitter® account of the user 701. In an embodiment, the generated unique secure random passwords are online account specific. The user 701 saves the generated unique secure random passwords in the database 201i maintained by the password management platform 201 via the GUI 201a.

The bookmark module 201e bookmarks one or more of the online accounts based on user preferences. The user 701 selects the preferred online accounts from the “List of all websites” 220 interface exemplarily illustrated in FIG. 2. The bookmark module 201e bookmarks the online accounts selected by the user 701 and when the user 701 accesses the password management platform 201, the bookmark module 201e automatically signs the user 701 into the bookmarked online accounts. The online account access module 201f, in communication with the bookmark module 201e, automatically inputs user names extracted from the acquired information of the bookmarked online accounts and either the user passwords or the generated unique secure random passwords associated with the bookmarked online accounts, when the bookmarked online accounts are accessed via the password management platform 201. The password generation module 201d generates a verification code and communicates the generated verification code to the notification module 201g. The notification module 201g transmits the generated verification code accessible to the user's 701 computing device 702 via the network 703 to provide access to the bookmarked online accounts, when the bookmarked online accounts are accessed independent of the password management platform 201.

In an embodiment, the authentication module 201h generates an authentication request for authenticating the user 701. The notification module 201g transmits the generated authentication request accessible to the user's 701 computing device 702 via the network 703 to provide access to the bookmarked online accounts, when the bookmarked online accounts are accessed independent of the password management platform 201. For example, the notification module 201g transmits an authentication request for one or more biometric identifiers to the user 701 via email or any of the communication modes. The authentication module 201h performs authentication of the user 701 using a response to the authentication request received from the user's 701 computing device 702. On reception of the biometric identifiers from the user 701 by the password management platform 201 via the network 703, the authentication module 201h compares the received biometric identifiers with the biometric information provided by the user 701 during registration to biometrically authenticate the user 701. In another embodiment, the notification module 201g transmits both a verification code and an authentication request, for example, to the user's 701 email address or to the user's 701 computing device 702 using one or more of the communication modes, via the network 703 for authenticating the user 701 and allowing access to the bookmarked online accounts, when the bookmarked online accounts are accessed independent of the password management platform 201.

The database 201i stores the acquired information on the online accounts, the user passwords associated with the online accounts, the generated unique secure random passwords associated with the online accounts of the user 701, updates to the acquired information on the online accounts and the user passwords associated with the online accounts, user preferences, etc., for managing access to each of the online accounts. In an embodiment, the database 201i is configured to selectively store the user passwords or the generated unique secure random passwords associated with each of the online accounts based on user preferences for managing access to the online accounts. The database 201i provides centralized storage of the generated unique secure random passwords associated with the online accounts. The database 201i is, for example, a MySQL 5+ database. Most structured query language (SQL) statements used in the code used for implementing the password management platform 201 are, for example, stored procedures. The information acquisition module 201c is configured to acquire updates to the acquired information on the online accounts and the user passwords associated with the online accounts via the GUI 201a. The database 201i stores the acquired updates.

The notification module 201g of the password management platform 201 requests the user 701 to update an online account with the generated unique secure random password for the online account. The user 701 accesses the online account and changes the user password to the new unique secure random password generated by the password generation module 201d. The online account access module 201f provides direct access to the online accounts using the user passwords or the generated unique secure random passwords, for example, via a wireless communication protocol such as WiFi®. Once the password changing process is complete and confirmed, the user 701 is now allowed to access the online account via the password management platform 201 automatically without having to log in. The online account access module 201f enables the user 701 to automatically log in to the user's 701 online account via the password management platform 201. The password management platform 201 uses the user name provided by the user 701 and the generated unique random password to log into the user's 701 online account. Similarly, the online account access module 201f enables the user 701 to access one or more online accounts that are registered with the password management platform 201 as desired by the user 701. The notification module 201g generates and displays prompts to update the online accounts with the generated unique secure random passwords prior to accessing the online accounts via the password management platform 201.

In an embodiment, the password generation module 201d configures a time interval for automatically generating the unique secure random passwords for each of the online accounts based on user preferences. The notification module 201g transmits a password notification to each of the online accounts via the network 703 to replace the user passwords with the generated unique secure random passwords. Furthermore, in an embodiment, the notification module 201g transmits an intimation, for example, to the user's 701 email address or to the user's 701 computing device 702 via one or more of the communication modes, for example, email, a short message service, etc., regarding the replacement of the user passwords with the generated unique secure random passwords to allow the user 701 to access the online accounts with the generated unique secure random passwords.

The computer implemented method and system 700 disclosed herein provides a web browser based access to the password management platform 201, light elegant designs for the interfaces of the password management platform 201, browser compatibility, for example, with Internet Explorer® (IE) 8.0 of Microsoft Corporation and Mozilla® 5.0 of Mozilla Foundation for Windows® of Microsoft Corporation, and smart navigation tabs on the interfaces of the password management platform 201. The language for development of the password management platform 201 and data entry is, for example, English. The password management platform 201 runs on a web server, for example, Apache 2 with a secure sockets layer (SSL) certificate installed. The operating system of the web server is, for example, Linux. The instructions for implementing the password management platform 201 are written in a programming language, for example, Ruby 1.9.2, hypertext preprocessor (PHP) 5+, etc. The password management platform 201 comprises multiple interfaces as disclosed in the detailed description of FIG. 2. The interfaces of the password management platform 201 are created, for example, using a hypertext markup language (HTML), an editor such as Adobe® Dreamweaver® of Adobe Systems, Inc., UltraEdit® of IDM Computer Solutions, Inc., etc., and design software, for example, Adobe® Photoshop® of Adobe Systems, Inc, Adobe® Fireworks®, etc. The instructions for implementing the password management platform 201 are written as per coding standards, that is, the industry standards in HTML designs, naming conventions, database schema, etc. For example, the instructions are written with inline coding; the pages have a code block of the name of the person who developed the code, date, etc.; any internal “Sub” or “Function” routines in the code contains comments at the top that identify the name and purpose of the routine as well as a description of any calling parameters and return values, relevant page names, etc.

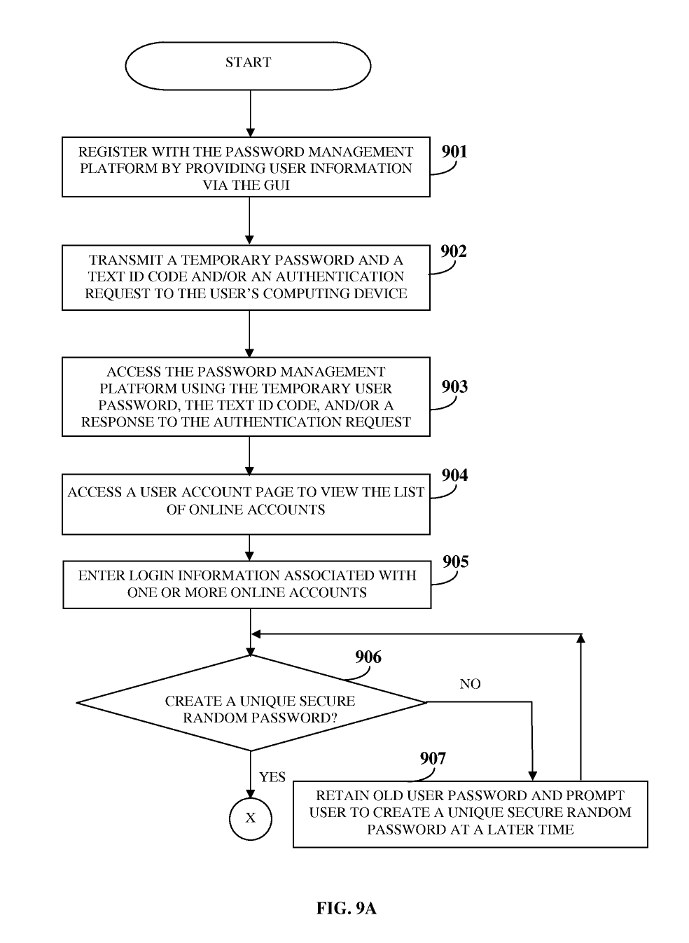

FIG. 8 exemplarily illustrates the architecture of a computer system 800 employed by the password management platform 201 for generating and managing multiple passwords associated with multiple online accounts. The password management platform 201 of the computer implemented system 700 exemplarily illustrated in FIG. 7 employs the architecture of the computer system 800 exemplarily illustrated in FIG. 8.

The password management platform 201 communicates with the user's 701 computing device 702 via a network 703, for example, a short range network or a long range network. The computer system 800 comprises a processor 801, a memory unit 802 for storing programs and data, an input/output (I/O) controller 803, a network interface 804, a data bus 805, a display unit 806, input devices 807, a fixed media drive 808, a removable media drive 809 for receiving removable media, output devices 810, etc. The processor 801 is an electronic circuit that executes computer programs. The memory unit 802 is used for storing programs, applications, and data. For example, the registration module 201b, the information acquisition module 201c, the password generation module 201d, the bookmark module 201e, the online account access module 201f, the notification module 201g, the authentication module 201h, etc., of the password management platform 201 are stored in the memory unit 802 of the computer system 800 of the password management platform 201. The memory unit 802 is, for example, a random access memory (RAM) or another type of dynamic storage device that stores information and instructions for execution by the processor 801. The memory unit 802 also stores temporary variables and other intermediate information used during execution of the instructions by the processor 801. The computer system 800 further comprises a read only memory (ROM) or another type of static storage device that stores static information and instructions for the processor 801.

The network interface 804 enables connection of the computer system 800 to the network 703. For example, the password management platform 201 connects to the network 703 via the network interface 804. The network interface 804 comprises, for example, an infrared (IR) interface, an interface implementing WiFi® of the Wireless Ethernet Compatibility Alliance, Inc., a universal serial bus (USB) interface, a local area network (LAN) interface, a wide area network (WAN) interface, etc. The I/O controller 803 controls input actions and output actions performed by the password management platform 201. The data bus 805 permits communications between the modules, for example, 201b, 201c, 201d, 201e, 201f, 201g, 201h, etc., of the password management platform 201.

The display unit 806 of the password management platform 201, via the GUI 201a, displays, for example, display interfaces, icons, user interface elements such as text fields, checkboxes, text boxes, etc., for allowing the user 701 to enter information on the online accounts and user passwords, for prompting the user 701 to update information on an online account, user information, etc. The input devices 807 are used for inputting data into the computer system 800. An operator of the password management platform 201 uses the input devices 807 to provide inputs to the password management platform 201. A user 701 enters information on the online accounts and the user passwords on the password management platform 201, etc., using input devices of the computing device 702. The input devices 807 are, for example, a keyboard such as an alphanumeric keyboard, a joystick, a pointing device such as a computer mouse, a touch pad, a light pen, etc. The output devices 810 output the results of operations performed by the password management platform 201. For example, the password management platform 201 displays a prompt window to the user 701 to prompt the user 701 to update changes made to the user password, to prompt the user 701 to update one or more online accounts with the generated unique random passwords, etc., using the output devices 810.

Computer applications and programs are used for operating the computer system 800. The programs are loaded onto the fixed media drive 808 and into the memory unit 802 of the computer system 800 via the removable media drive 809. In an embodiment, the computer applications and programs may be loaded on the computer system 800 directly via the network 703. Computer applications and programs are executed by double clicking a related icon displayed on the display unit 806 using one of the input devices 807. The computer system 800 employs an operating system for performing multiple tasks. The operating system is responsible for management and coordination of activities, and sharing of resources of the computer system 800. The operating system further manages security of the computer system 800, peripheral devices connected to the computer system 800, and network connections. The operating system employed on the computer system 800 recognizes, for example, inputs provided by the user 701 via the GUI 201a or by an operator using one of the input devices 807, the output display, files, and directories stored locally on the fixed media drive 808, for example, a hard drive. The operating system on the computer system 800 executes different programs using the processor 801. The processor 801 retrieves instructions for executing the modules, for example, 201b, 201c, 201d, 201e, 201f, 201g, 201h, etc., of the password management platform 201 from the memory unit 802. A program counter determines the location of the instructions in the memory unit 802. The program counter stores a number that identifies the current position in the program of each of the modules, for example, 201b, 201c, 201d, 201e, 201f, 201g, 201h, etc., of the password management platform 201.

The instructions fetched by the processor 801 from the memory unit 802 after being processed are decoded. The instructions are stored in an instruction register in the processor 801. After processing and decoding, the processor 801 executes the instructions. For example, the registration module 201b defines instructions for registering users 701 associated with the online accounts, with the password management platform 201. The password generation module 201d defines instructions for generating a temporary password and a verification code and/or an authentication request accessible to the user's 701 computing device 702 via the network 703 for authenticating the user 701 and providing access to the password management platform 201. The notification module 201g defines instructions for transmitting the generated temporary password, for example, to the user's 701 email address, and the verification code and/or the authentication request to the user's 701 computing device 702 using one or more of multiple communication modes, for example, electronic mail, a short message service message, a multimedia messaging service message, a telephonic message, etc., via the network 703. The information acquisition module 201c defines instructions for acquiring information of the user's 701 online accounts and user passwords associated with the online accounts via the GUI 201a and storing the acquired information and the user passwords in the database 201i. The password generation module 201d defines instructions for generating one or more unique secure random passwords to replace the user passwords for each of the online accounts, on receiving an indication from the user 701 via the GUI 201a. The notification module 201g defines instructions for generating and displaying prompts to update the online accounts with the generated unique secure random passwords prior to accessing the online accounts via the password management platform 201. The information acquisition module 201c defines instructions for acquiring updates made to the acquired information on the online accounts and the user passwords associated with the online accounts via the GUI 201a and storing the updates in the database 201i.

The bookmark module 201e defines instructions for bookmarking one or more of the online accounts based on user preferences. The online account access module 201f defines instructions for providing direct access to one or more of the online accounts using the user passwords or the generated unique secure random passwords, for example, via a wireless communication protocol such as WiFi®. Furthermore, the online account access module 201f defines instructions for automatically inputting the user names extracted from the acquired information of the bookmarked online accounts and either the user passwords or the generated unique secure random passwords associated with the bookmarked online accounts, when the bookmarked online accounts are accessed via the password management platform 201. The notification module 201g defines instructions for generating and displaying prompts to update the online accounts with the generated unique secure random passwords prior to accessing the online accounts via the password management platform 201. Furthermore, the password generation module 201d defines instructions for generating a verification code and/or an authentication request for authenticating the user 701 and providing access to the bookmarked online accounts. The notification module 201g defines instructions for transmitting the generated verification code and/or the authentication request accessible to the computing device 702 via the network 703 to provide access to the bookmarked online accounts, when the bookmarked online accounts are accessed independent of the password management platform 201. The authentication module 201h defines instructions for performing authentication of the user 701, for example, a biometric authentication using a response to the authentication request, for example, a biometric identifier received from the user 701 via the user's 701 computing device 702.

The password generation module 201d defines instructions for configuring a time interval for automatically generating the unique secure random passwords for each of the online accounts based on user preferences. The notification module 201g defines instructions for transmitting a password notification to each of the online accounts via the network 703 to replace the user passwords with the generated unique secure random passwords. Furthermore, in an embodiment, the notification module 201g defines instructions for transmitting an intimation, for example, to the user's 701 email address or to the user's 701 computing device 702 via one or more of the communication modes, for example, email, a short message service, etc., regarding the replacement of the user passwords with the generated unique secure random passwords to allow the user 701 to access the online accounts with the generated unique secure random passwords.

The processor 801 of the computer system 800 employed by the password management platform 201 retrieves the instructions defined by the registration module 201b, the information acquisition module 201c, the password generation module 201d, the bookmark module 201e, the online account access module 201f, the notification module 201g, and the authentication module 201h of the password management platform 201 and executes the instructions for generating and managing multiple passwords associated with multiple online accounts.

At the time of execution, the instructions stored in the instruction register are examined to determine the operations to be performed. The processor 801 then performs the specified operations. The operations comprise arithmetic operations and logic operations. The operating system performs multiple routines for performing a number of tasks required to assign the input devices 807, the output devices 810, and memory for execution of the modules, for example, 201b, 201c, 201d, 201e, 201f, 201g, 201h, etc., of the password management platform 201. The tasks performed by the operating system comprise, for example, assigning memory to the modules, for example, 201b, 201c, 201d, 201e, 201f, 201g, 201h, etc., of the password management platform 201, and to data used by the password management platform 201, moving data between the memory unit 802 and disk units, and handling input/output operations. The operating system performs the tasks on request by the operations and after performing the tasks, the operating system transfers the execution control back to the processor 801. The processor 801 continues the execution to obtain one or more outputs. The outputs of the execution of the modules, for example, 201b, 201c, 201d, 201e, 201f, 201g, 201h, etc., of the password management platform 201 are displayed to the user 701 on the display unit 806.

For purposes of illustration, the detailed description refers to the password management platform 201 being run locally on a computer system 800; however the scope of the computer implemented method and system 700 disclosed herein is not limited to the password management platform 201 being run locally on the computer system 800 via the operating system and the processor 801, but may be extended to run remotely over the network 703 by employing a web browser and a remote server, a mobile phone, or other electronic devices.

Disclosed herein is also a computer program product comprising a non-transitory computer readable storage medium that stores computer program codes comprising instructions executable by at least one processor 801 for generating and managing multiple passwords associated with multiple online accounts. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 801, except for a transitory, propagating signal.

The computer program codes comprise a first computer program code for acquiring information on online accounts and user passwords associated with the online accounts via the GUI 201a provided by the password management platform 201; a second computer program code for generating one or more unique secure random passwords to replace the user passwords for each of the online accounts based on the inputs received from the user 701 via the GUI 201a; a third computer program code for selectively storing the user passwords or the generated unique secure random passwords associated with each of the online accounts based on user preferences for managing access to each of the online accounts; and a fourth computer program code for directly accessing the online accounts using the user passwords or the generated unique secure random passwords via the password management platform 201. The computer program product disclosed herein further comprises one or more additional computer program codes for performing additional steps that may be required and contemplated for generating and managing multiple passwords associated with multiple online accounts. In an embodiment, a single piece of computer program code comprising computer executable instructions performs one or more steps of the computer implemented method disclosed herein for generating and managing multiple passwords associated with multiple online accounts.

The computer program codes comprising computer executable instructions are embodied on the non-transitory computer readable storage medium. The processor 801 of the computer system 800 retrieves these computer executable instructions and executes them. When the computer executable instructions are executed by the processor 801, the computer executable instructions cause the processor 801 to perform the steps of the computer implemented method for generating and managing multiple passwords associated with multiple online accounts.

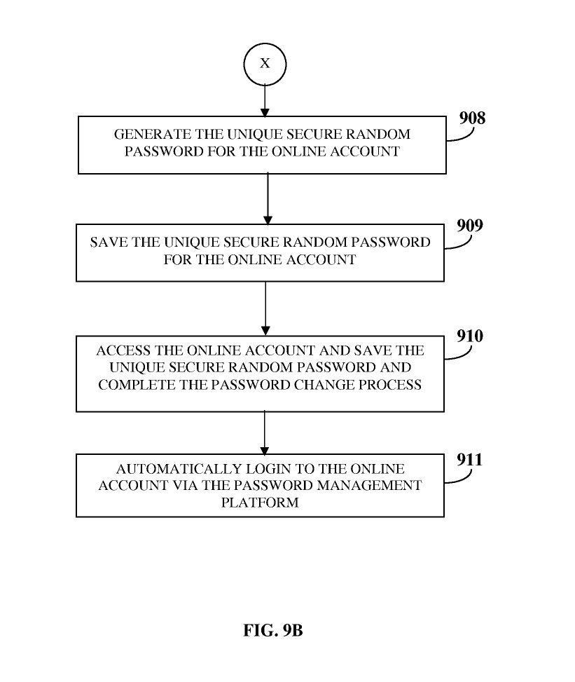

FIGS. 9A-9B exemplarily illustrate a flowchart comprising the steps performed by the password management platform 201 shown in FIG. 2 and FIG. 7, for generating and managing multiple passwords associated with multiple online accounts. Consider an example where a user 701 Sam accesses the password management platform 201 for creating multiple unique secure random passwords associated with multiple online accounts. The password management platform 201 prompts Sam to register 901 with the password management platform 201 via the GUI 201a. Sam provides user information required for the registration, for example, full name, a password management platform specific user name, a telephone number, an email address, biometric identifiers, etc. When the registration is complete, the password management platform 201 transmits 902 a temporary password, a verification or identification (ID) code, and/or an authentication request via email, a text message, etc., to Sam's computing device 702. Sam accesses his computing device 702 and uses the temporary user password, the verification code, and/or provides a response to the authentication request to access 903 the password management platform 201. In an embodiment, the password management platform 201 prompts Sam to change the temporary password when he logs in using the temporary password. Sam needs to enter the password twice, for example, enter a new password and then reconfirm the password in order to complete the registration process. The password management platform 201 transmits the new password created to Sam, for example, to his registered email address. Furthermore, Sam will need to enter the username, the new password, the text ID code, and/or a response to the authentication request that was sent to the computing device 702 for the future logins to the password management platform 201. At this stage in the process, the registration process is complete and Sam has a user account of his own maintained by the password management platform 201.

The password management platform 201 then directs Sam to the “My Account” 204 interface exemplarily illustrated in FIG. 2, where he can provide information on his online accounts, for example, Facebook®, Twitter®, LinkedIn®, etc., and the associated user passwords. Sam may access 904 user account page to view the list of the online accounts, for example, Facebook®, Twitter®, LinkedIn®, etc., on the GUI 201a. The password management platform 201 displays a “create password” button next to each online account link as exemplarily illustrated in FIGS. 3-5. Consider an example where Sam wants to create a unique secure random password for his LinkedIn® account. Sam clicks on the LinkedIn® button and the password management platform 201 prompts Sam to enter 905 the login information, for example, email address, user name, user password, etc., associated with his LinkedIn® account. When Sam clicks on the “create password” button, the password management platform 201 prompts Sam by displaying a pop-up window that requests Sam whether he wishes to create 906 a unique secure random password? If Sam does not wish to create a unique secure random password for the LinkedIn® account, the password management platform 201 retains 907 the old user password and prompts Sam to change or create a unique secure random password at a later time. If Sam confirms creation of the unique secure random password, the password management platform 201 generates 908 a unique secure random password for the LinkedIn® account.

Once the password management platform 201 generates the unique random password for Sam's LinkedIn® account, Sam can request the password management platform 201 to save 909 the unique secure random password for the LinkedIn® account. The password management platform 201 saves the unique random password in the database 201i maintained by the password management platform 201 as exemplarily illustrated in FIG. 7. Similarly, Sam can access the password management platform 201 to generate unique random passwords for one or more online accounts, for example, a Facebook® account, a Twitter® account, etc., that are registered with the password management platform 201. In an embodiment, Sam can modify or change the user password and the generated unique random passwords as desired and request the password management platform 201 to generate new unique random passwords associated with one or more online accounts as desired. The password management platform 201 acquires the updates made to the online accounts and the generated unique random passwords and stores the updates in the database 201i.

The password management platform 201 then prompts Sam to access 910 the LinkedIn® account, update and save the change in password, and complete the password change process. Sam enters the generated unique random password and then reenters the unique secure random password and confirms the password change process for the LinkedIn® account. This process helps associate the LinkedIn® account to the password management platform 201 securely. Sam can now automatically login 911 to the LinkedIn® account via the password management platform 201. On accessing the password management platform 201, Sam is automatically logged in to one or more online accounts by using the unique secure random passwords generated by the password management platform 201. Sam can now access the online accounts securely and automatically via the password management platform 201.

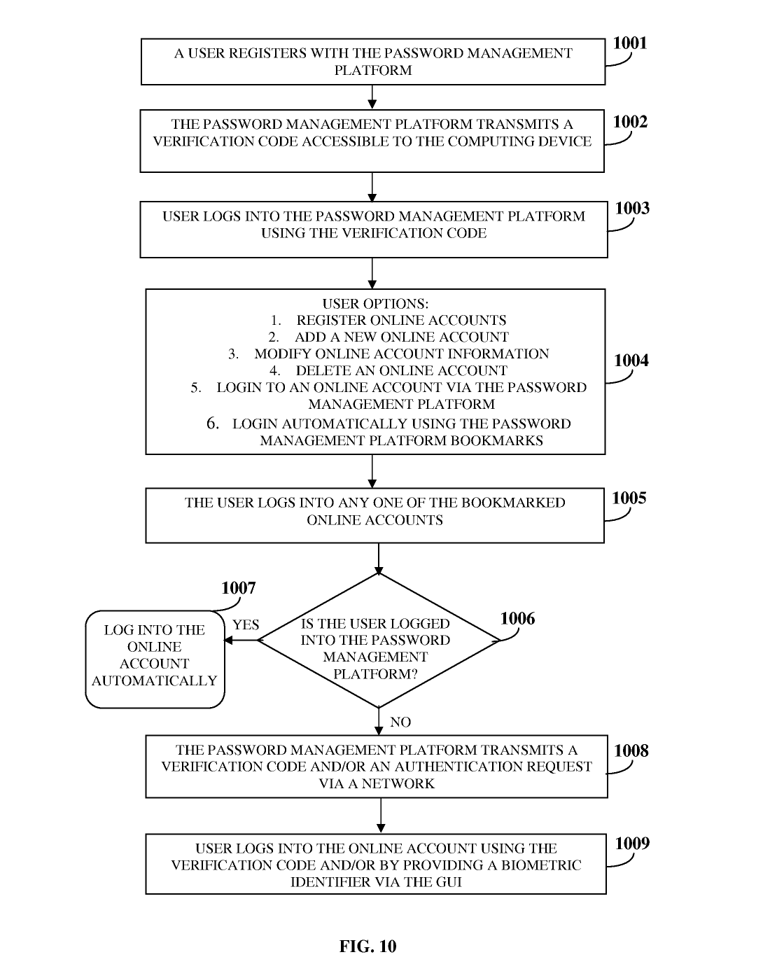

FIG. 10 exemplarily illustrates a flowchart comprising the steps performed by the password management platform 201 shown in FIG. 2 and FIG. 7, when a user 701 accesses bookmarked online accounts. Consider an example where a user 701 registers 1001 with the password management platform 201 by providing user information, login information, biometric information, etc., as requested by the password management platform 201 in order to complete registration successfully. Once the user 701 submits the requested information, the password management platform 201 transmits 1002 a verification code, for example, a text identification (ID) code accessible to the user's 701 computing device 702, for example, via electronic mail (email). The user 701 may then log in 1003 to the password management platform 201 using the verification code and access the user account, that is, a “My Account” 204 interface of the password management platform 201 on the graphical user interface (GUI) 201a.

After successful login, the user 701 can access multiple options 1004 provided by the password management platform 201. The options 1004 provided by the password management platform 201 comprise, for example, the ability to register one or more online accounts, the ability to add a new online account to the existing list of online accounts, the ability to modify online account information provided at an earlier date, the ability to delete an online account if no longer required, the ability to log in to the online accounts via the password management platform 201, the ability to login automatically and access bookmarked online accounts, etc. The password management platform 201 also bookmarks frequently used online accounts based on user preferences. For example, if the user 701 uses only two online accounts frequently and the remaining online accounts occasionally, the password management platform 201 enables the user 701 to bookmark the frequently used online accounts. The password management platform 201 automatically inputs the user name and either the user passwords or the generated unique secure random passwords associated with the bookmarked online accounts to allow the user 701 to automatically log into the bookmarked online accounts, when the user 701 logs into the password management platform 201.

If the user 701 logs 1005 into any one of the online accounts that are bookmarked by the password management platform 201, the password management platform 201 checks 1006 if the user 701 is logged into the password management platform 201. If the user 701 is logged into the password management platform 201, the password management platform 201 logs 1007 the user 701 into the bookmarked online accounts automatically. If the user 701 is not logged into the password management platform 201 and instead directly uses a browser on the user's 701 computing device 702 to access any of the bookmarked online accounts, the password management platform 201 transmits 1008 a verification code and/or an authentication request for a biometric identifier to the user's 701 computing device 702 or to the user's 701 email address via the network 703. The user 701 may then log 1009 into the bookmarked online accounts through the browser using the verification code and/or by providing a biometric identifier to the password management platform 201 via the GUI 201a via the network 703. The user 701 may provide the biometric identifier by performing an iris scan, or by capturing a fingerprint, hand geometry, a palm print, a face image, voice prints, etc., using a scanner and/or recognition software such as voice recognition software on the computing device 702 and transmitting the biometric identifier to the password management platform 201 via the network 703. The password management platform 201 verifies the verification code entered by the user 701 and/or performs biometric authentication of the user 701 to allow access to the bookmarked online accounts.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises one or more computer program codes for implementing the processes of various embodiments.

Where databases are described such as the database 201i, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for generating and managing a plurality of passwords associated with a plurality of online accounts, comprising:
providing a password management platform accessible by a computing device via a network, said password management platform comprising at least one processor configured to generate and manage said passwords associated with said online accounts;
acquiring information on said online accounts and user passwords associated with said online accounts via a graphical user interface provided by said password management platform;
generating one or more unique secure random passwords to replace said user passwords for each of one or more of said online accounts by said password management platform, on receiving an indication via said graphical user interface; and
storing said generated one or more unique secure random passwords associated with said each of said one or more of said online accounts by said password management platform for managing access to said each of said one or more of said online accounts.

2. The computer implemented method of claim 1, further comprising providing direct said access to said online accounts using one of said user passwords and said generated one or more unique secure random passwords by said password management platform.

3. The computer implemented method of claim 1, further comprising registering users associated with said online accounts, with said password management platform via said graphical user interface.

4. The computer implemented method of claim 1, wherein said generated one or more unique secure random passwords comprise one or more of a random number, a random string of alphanumeric characters, symbols, and any combination thereof.

5. The computer implemented method of claim 1, wherein said password management platform provides said access to said each of said one or more of said online accounts using one of said user passwords and said generated one or more unique secure random passwords via a wireless communication protocol.

6. The computer implemented method of claim 1, further comprising generating and transmitting a temporary password and one or more of a verification code and an authentication request accessible to said computing device via said network using one or more of a plurality of communication modes by said password management platform for allowing said access to said password management platform, wherein said verification code is one of a random code and a fixed code, and wherein said authentication request comprises a request for one or more biometric identifiers for performing biometric authentication.

7. The computer implemented method of claim 1, further comprising acquiring updates to said acquired information on said online accounts and said user passwords associated with said online accounts by said password management platform via said graphical user interface.

8. The computer implemented method of claim 1, further comprising providing a database configured to store said acquired information on said online accounts, said user passwords associated with said online accounts, said generated one or more unique secure random passwords, updates to said acquired information on said online accounts and said user passwords associated with said online accounts, and user preferences, by said password management platform.

9. The computer implemented method of claim 1, further comprising generating and displaying prompts to update said online accounts with said generated one or more unique secure random passwords by said password management platform prior to accessing said online accounts via said password management platform.

10. The computer implemented method of claim 1, further comprising configuring a time interval for automatically generating said one or more unique secure random passwords for said each of said one or more of said online accounts by said password management platform based on user preferences.

11. The computer implemented method of claim 1, further comprising transmitting a password notification to said each of said one or more of said online accounts by said password management platform via said network to replace said user passwords with said generated one or more unique secure random passwords.

12. The computer implemented method of claim 1, further comprising bookmarking one or more of said online accounts by said password management platform based on user preferences.

13. The computer implemented method of claim 12, further comprising automatically inputting user names extracted from said acquired information of said bookmarked one or more of said online accounts and one of said user passwords and said generated one or more unique secure random passwords associated with said bookmarked one or more of said online accounts by said password management platform when said bookmarked one or more of said online accounts are accessed via said password management platform.

14. The computer implemented method of claim 12, further comprising generating and transmitting one or more of a verification code and an authentication request accessible to said computing device via said network, by said password management platform to provide said access to said bookmarked one or more of said online accounts, when said bookmarked one or more of said online accounts are accessed independent of said password management platform, wherein said authentication request comprises a request for one or more biometric identifiers for performing biometric authentication.

15. The computer implemented method of claim 1, further comprising selectively storing one of said user passwords and said generated one or more unique secure random passwords associated with said online accounts by said password management platform based on user preferences.

16. The computer implemented method of claim 1, further comprising transmitting an intimation to said computing device by said password management platform via said network using one or more of a plurality of communication modes, regarding said replacement of said user passwords with said generated one or more unique secure random passwords.

17. A computer implemented system for generating and managing a plurality of passwords associated with a plurality of online accounts, comprising:
a password management platform accessible by a computing device via a network, said password management platform comprising:
at least one processor;
a non-transitory computer readable storage medium communicatively coupled to said at least one processor, said non-transitory computer readable storage medium configured to store modules of said password management platform, said at least one processor configured to execute said modules of said password management platform;
said modules of said password management platform comprising:
an information acquisition module configured to acquire information on said online accounts and user passwords associated with said online accounts via a graphical user interface provided by said password management platform;
a password generation module configured to generate one or more unique secure random passwords to replace said user passwords for each of one or more of said online accounts, on receiving an indication via said graphical user interface; and
a database configured to selectively store one of said user passwords and said generated one or more unique secure random passwords associated with said each of said one or more of said online accounts based on user preferences for managing access to said each of said one or more of said online accounts.

18. The computer implemented system of claim 17, wherein said modules of said password management platform further comprise an online account access module configured to provide direct said access to said online accounts using one of said user passwords and said generated one or more unique secure random passwords.

19. The computer implemented system of claim 18, wherein said online account access module is configured to provide said access to said each of said one or more of said online accounts using one of said user passwords and said generated one or more unique secure random passwords via a wireless communication protocol.

20. The computer implemented system of claim 17, wherein said password generation module is configured to configure a time interval for automatically generating said one or more unique secure random passwords for said each of said one or more of said online accounts based on user preferences.

21. The computer implemented system of claim 17, wherein said modules of said password management platform further comprise a notification module configured to transmit a password notification to said each of said one or more of said online accounts via said network to replace said user passwords with said generated one or more unique secure random passwords.

22. The computer implemented system of claim 21, wherein said notification module is configured to transmit an intimation to said computing device via said network using one or more of a plurality of communication modes, regarding said replacement of said user passwords with said generated one or more unique secure random passwords.

23. The computer implemented system of claim 21, wherein said notification module is configured to generate and display prompts to update said online accounts with said generated one or more unique secure random passwords prior to accessing said online accounts via said password management platform.

24. The computer implemented system of claim 21, wherein said notification module is configured to transmit a temporary password and one or more of a verification code and an authentication request accessible to said computing device via said network using one or more of a plurality of communication modes for allowing said access to said password management platform, wherein said verification code is one of a random code and a fixed code, and wherein said authentication request comprises a request for one or more biometric identifiers for performing biometric authentication.

25. The computer implemented system of claim 17, wherein said modules of said password management platform further comprise a registration module configured to register users associated with said online accounts, with said password management platform via said graphical user interface.

26. The computer implemented system of claim 17, wherein said database is configured to store said acquired information on said online accounts, said user passwords associated with said online accounts, said generated one or more unique secure random passwords, updates to said acquired information on said online accounts and said user passwords associated with said online accounts, and user preferences.

27. The computer implemented system of claim 17, wherein said generated one or more unique secure random passwords comprise one or more of a random number, a random string of alphanumeric characters, symbols, and any combination thereof.

28. The computer implemented system of claim 17, wherein said information acquisition module is configured to acquire updates to said acquired information on said online accounts and said user passwords associated with said online accounts via said graphical user interface.

29. The computer implemented system of claim 17, wherein said modules of said password management platform further comprise a bookmark module configured to bookmark one or more of said online accounts based on user preferences.

30. The computer implemented system of claim 29, wherein said modules of said password management platform further comprise an online account access module, in communication with said bookmark module, configured to automatically input user names extracted from said acquired information of said bookmarked one or more of said online accounts and one of said user passwords and said generated one or more unique secure random passwords associated with said bookmarked one or more of said online accounts when said bookmarked one or more of said online accounts are accessed via said password management platform.

31. The computer implemented system of claim 29, wherein said modules of said password management platform further comprise:
a notification module configured to transmit one or more of a verification code and an authentication request accessible to said computing device via said network to provide said access to said bookmarked one or more of said online accounts, when said bookmarked one or more of said online accounts are accessed independent of said password management platform, wherein said authentication request comprises a request for one or more biometric identifiers for performing biometric authentication; and
an authentication module configured to perform authentication using said verification code and a response to said authentication request received from said computing device.

32. A computer program product comprising a non-transitory computer readable storage medium, said non-transitory computer readable storage medium storing computer program codes comprising instructions executable by at least one processor, said computer program codes comprising:
a first computer program code for acquiring information on online accounts and user passwords associated with said online accounts via a graphical user interface provided by a password management platform;
a second computer program code for generating one or more unique secure random passwords to replace said user passwords for each of one or more of said online accounts;
a third computer program code for selectively storing one of said user passwords and said generated one or more unique secure random passwords associated with said each of said one or more of said online accounts based on user preferences for managing access to said each of said one or more of said online accounts; and
a fourth computer program code for directly accessing said online accounts using said one of said user passwords and said generated one or more unique secure random passwords via said password management platform.
